(19) United States
(12) Patent Application Publication
(10) Pub. No.: US 2010/0019029 A1
(43) Pub. Date: Jan. 28, 2010

(54) TWO-SECTION RELOADABLE FINANCIAL TRANSACTION PRODUCT

(75) Inventors: Mark SCHULTZ, Burnsville, MN (US); Anne L. COUCH, Woodbury, MN (US); Kathy HARTLEY, Brooklyn Park, MN (US); Tim TORMOEN, Minneapolis, MN (US)

Correspondence Address: TARGET BRANDS, INC., 1000 NICOLLET MALL, TPS-3165, MINNEAPOLIS, MN, 55403, US

(73) Assignee: TARGET BRANDS, INC., MINNEAPOLIS, MN (US)

(21) Appl. No.: 12/568,624

(22) Filed: Sep. 28, 2009

Related U.S. Application Data
(62) Division of application No. 10/877,062, filed on Jun. 25, 2004.

(51) Int. Cl. G07F 19/00; G06K 19/00

(52) U.S. Cl. 235/379; 235/487

(57) ABSTRACT

A financial transaction product includes a generally planar structure, which includes a first generally rectangular section and a second generally rectangular section. The first generally rectangular section includes first encoding means for associating the first generally rectangular section with a financial account and first indicia associated with a retail chain. The first generally rectangular section is adapted for use as a stored-value card. The second generally rectangular section includes second encoding means for associating the second generally rectangular section with the same financial account and second indicia associated with the same retail chain as the first indicia. The second generally rectangular section is adapted for use as a stored-value card. A lateral score line separates the first generally rectangular section from the second generally rectangular section with lateral edges of the first and second generally rectangular sections being joined along the lateral score line.

### CROSS-REFERENCE TO RELATED APPLICATION

This application is a divisional of and claims priority to U.S. patent application Ser. No. 10/877,062, filed Jun. 25, 2004, which is incorporated herein by reference.

### BACKGROUND OF THE INVENTION

Stored-value cards and other financial-transaction cards come in many forms. A gift card, for example, is a type of stored-value card that includes pre-loaded or selectably loaded monetary value. In one example, a customer buys a gift card having a specified value for presentation as a gift to another person. In another example, a customer is offered a gift card as an incentive to make a purchase. A gift card, like other stored-value cards, can be “recharged” or “reloaded” at the direction of the bearer. The balance associated with the card declines as the card is used, encouraging repeat visits to the retailer or other provider issuing the card. Additionally, the card generally remains in the user's purse or wallet, serving as an advertisement or reminder to revisit the associated retailer. Gift cards provide a number of advantages, to both the customer and the retailer.

### SUMMARY OF THE INVENTION

A financial transaction product includes a generally planar structure, which includes a first generally rectangular section and a second generally rectangular section. The first generally rectangular section includes first encoding means for associating the first generally rectangular section with a financial account and first indicia associated with a retail chain. The first generally rectangular section is adapted for use as a stored-value card. The second generally rectangular section includes second encoding means for associating the second generally rectangular section with the same financial account and second indicia associated with the same retail chain as the first indicia. The second generally rectangular section is adapted for use as a stored-value card. A lateral score line separates the first generally rectangular section from the second generally rectangular section with lateral edges of the first and second generally rectangular sections being joined along the lateral score line.

### BRIEF DESCRIPTION OF THE DRAWINGS

Embodiments of the invention will be described with respect to the figures, in which like reference numerals denote like elements, and in which:

FIG. 1 is a front view of a card assembly, according to an embodiment of the invention.

FIG. 2 is a rear view of the FIG. 1 assembly, according to an embodiment of the invention.

FIG. 3 is a front view of a carrier for the FIG. 1 assembly, according to an embodiment of the invention.

FIG. 4 is a rear view of the FIG. 3 carrier, according to an embodiment of the invention.

FIG. 5 is a flow chart showing a method according to an embodiment of the invention.

FIG. 6 is a schematic illustration including different stores and geographic regions, according to an embodiment of the invention.

FIGS. 7-8 are flow charts showing methods according to embodiments of the invention.

### DETAILED DESCRIPTION

A gift card or other stored-value card according to embodiments of the invention includes a “shared” bar code or other indicia or device linking the card to a common financial account or record. A two-piece gift card is provided, each piece having identical bar codes and each piece functioning as a separate gift card. One intent is for a parent or other provider to load a dollar amount on a credit-card-sized gift card, and then give the gift card to their student, dependent or other recipient, while keeping a smaller-sized “reloader” card for themselves. The reloader is for the parent to take to any store, e.g. any store in a chain of retail stores, to add additional dollars to the account or record, effectively loading the student's gift card with additional value that the student can redeem at a retail store that is local to the student or at a website of the retail store chain, for example. Parents thus have a controlled spending tool, in the manner of giving their child an allowance that can be spent only at the retail store and not in a cash form that could be spent on alcohol, tobacco, or some other product of which the parent does not approve. Should the student decide that they do not want to redeem their gift card dollars, the reloader card also can be redeemed at any of the retail stores in the chain or on the website.

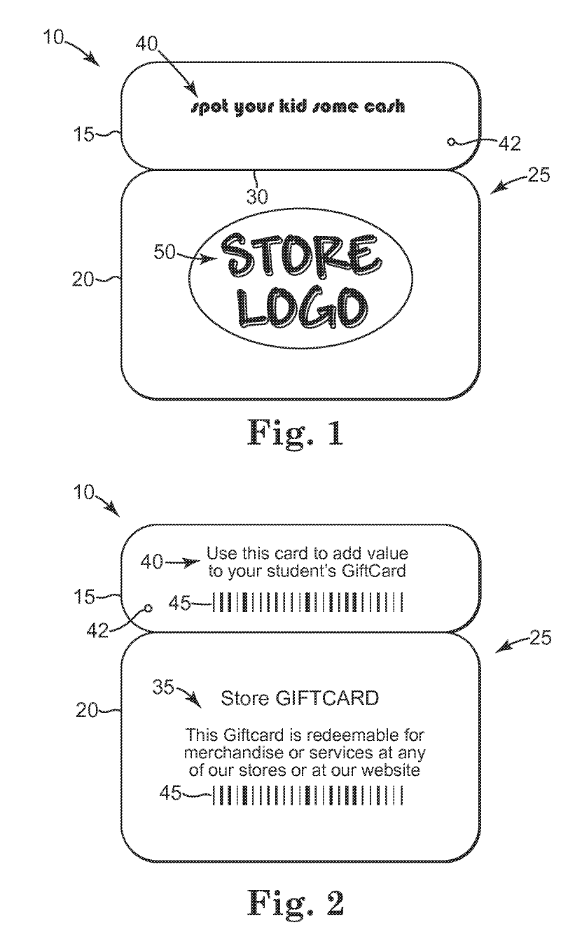

One embodiment of a reloadable stored-value card assembly is shown in FIGS. 1-2. Assembly 10 comprises stored-value card 20, adapted for use in making purchases of goods and/or services from e.g. a retail store or website, and reloader card 15, separable from stored value card 20, adapted for loading value on stored-value card 20. Stored-value card 20 and reloader card 15 are initially attached together but are readily separable at a desired time, for example after initial purchase of assembly 10.

Stored-value card 20 and reloader card 15 each share a common bar code, and each are linked to a common financial account or record. An account or record of the monetary balance on the card optionally is maintained on a database, other electronic or manual record-keeping system, or, in the case of “smart” cards, for example, on a chip or other electronics or devices on the card itself. Stored-value card 20 is physically larger than reloader card 15, according to the illustrated embodiment, although stored-value card also may be smaller than or the same size as reloader card 15. According to the illustrated embodiment, stored-value card 20 is the size of a typical gift card or credit card, and reloader card 15 is about one-third that size. As will be described, stored-value card 20 is also adapted for loading value on itself, i.e. either reloader card 15 or stored-value card 20 can be used for adding value to the financial account or record associated with assembly 10. Similarly, reloader card 15 is also adapted for use in purchasing goods and/or services from a retail store or website, i.e. either reloader card 15 or stored-value card 20 may be used in the manner of a typical gift card or stored-value card. According to embodiments of the invention, then, assembly 10 comprises gift card 20 and means for reloading gift card 20, the means for reloading including, for example, reloader card 15. The means for reloading is readily releasably attached to gift card 20 and itself is useable as a gift card.

Stated differently, assembly 10 is a two-piece card, comprising first piece 15, adapted for access to a financial account or record, and second piece 20, readily releasably attached to first piece 15 and also adapted for access to the financial account or record. First piece 15 and second piece 20 are formed from a common substrate 25 having score line 30 adapted for separating first piece 15 from second piece 20. Score line 30 optionally is in the form of a narrowing, cut, perforation, weakening, or other feature allowing ready release or separation of first piece 15 from second piece 20.

Second piece 20 supports indicia 35 indicating that second piece 20 is for the purchase of goods and/or services, a value of the purchased goods and/or services to be deducted from the financial account or record. According to one embodiment, indicia 35 include phrases such as “<Name of Store> GiftCard”, and/or “This GiftCard is redeemable for merchandise or services at any of our stores or at our website.” First piece 15 supports indicia 40 indicating that first piece 15 is for adding value to the financial account or record. According to one embodiment, indicia 40 include phrases such as “Use this card to add value to your student's GiftCard.” and/or “Spot your kid some cash.” First piece 15 advantageously defines hole 42 for securement of first piece 15 to a keychain or key ring, such that first piece 15 is readily and repeatedly visible to e.g. a parent or other user, serving as a reminder to visit the retail store or website and add value to the financial account or record.

First piece 15 and second piece 20 also comprise indicia 45 respectively linking first piece 15 and second piece 20 to the financial account or record. According to the illustrated embodiment, indicia 45 comprise generally identical bar codes supported by first piece 15 and second piece 20. First piece 15 and second piece 20 thus share a common bar code. If desired, either first piece 15 or second piece 20 may be used as a stored-value card for the purchase of goods and/or services, a value thereof to be deducted from the financial account or record. Thus, in the case where a student or other recipient of second piece 20 chooses not to redeem the available value, the parent or other provider of second piece 20 may use first piece 15 to purchase goods and/or services and thus redeem the value themselves. Similarly, second piece 20 may be used to add value to the financial account or record, i.e. to reload itself and first piece 15.

First piece 15 and/or second piece 20 optionally include additional indicia, graphics or text information including store logo 50, store name(s), slogans, advertising, instructions, directions, brand indicia, promotional information, and/or other information. According to specific examples, such indicia include indications that neither first piece 15 nor second piece 20 are redeemable for cash or credit except where required by law, instructions on how to report a lost, stolen or damaged card, an instruction that the remaining value of such a card can be replaced upon presenting the original purchase receipt, card numbers, event numbers, access numbers, copyright and trademark indications, reservations of rights, and other indications.

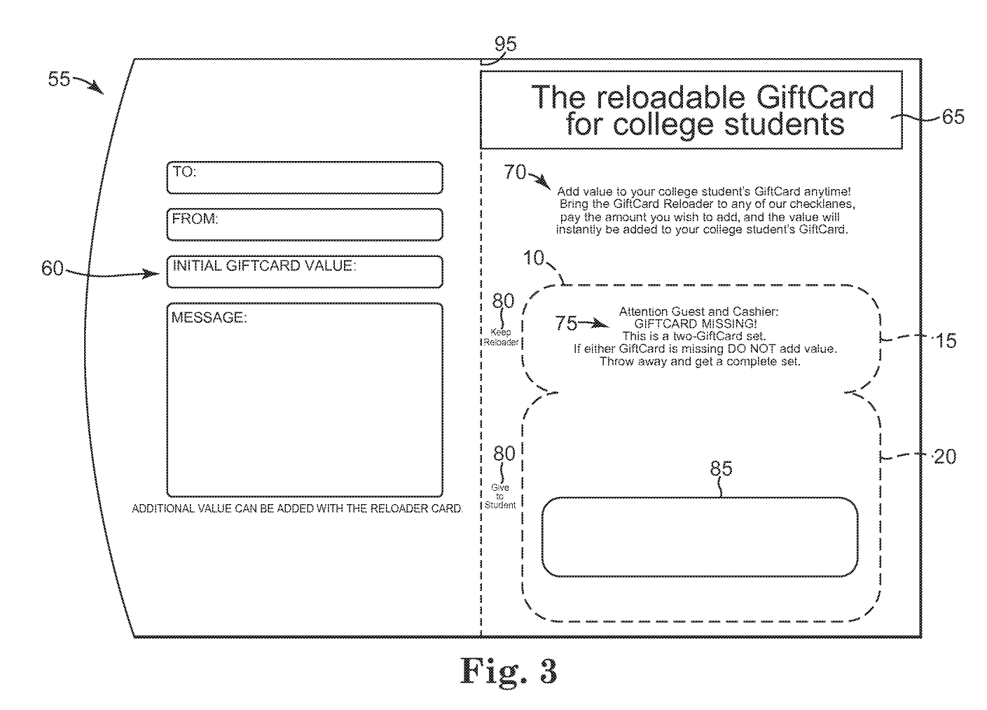

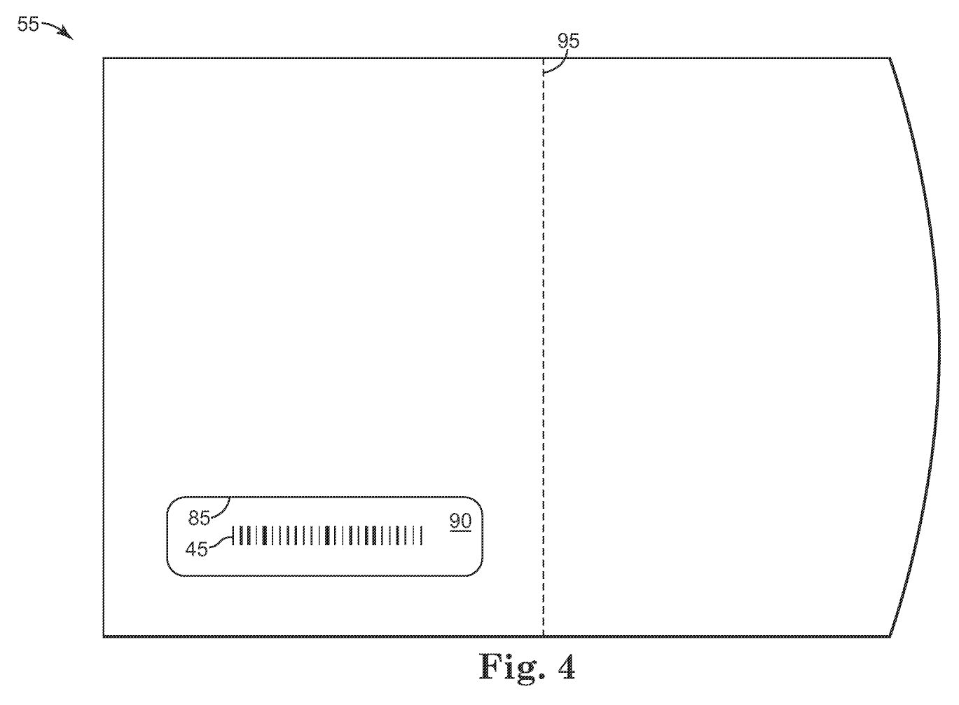

FIGS. 3-4 illustrate carrier or backer 55 for supporting first piece 15 and second piece 20. First piece 15 and second piece 20 of card 10 are readily releasably attached to carrier 55, for example by adhesive or the like, and are represented in dashed lines in FIG. 3. Backer 55 comprises a single layer or multiple layers of paper or plastic material, for example, generally in the form of a relatively stiff but bendable/flexible card. Other materials are also contemplated.

Backer 55 displays indicia, graphics or text information including store logo(s), store name(s), slogans, advertising, instructions, directions, brand indicia, promotional information, and/or other information. Indicia 60, for example, include To, From, Initial GiftCard Value, and Message fields, as well as an indication that additional value can be added with the reloader card supported by backer 55. Indicia 65 promote that card 10 is reloadable and is for college students, according to one example. Indicia 70 include instructions, for example “Add value to your college student's GiftCard anytime! Bring the GiftCard Reloader to any of our checklanes, pay the amount you wish to add, and the value will instantly be added to your college student's GiftCard.”

Indicia 75 are initially covered by first piece 15 of card 10. If first piece 15 is absent from backer 55, indicia 75 are visible to the initial purchaser of card 10. Indicia 75 state, according to one example, “Attention Guest and Cashier: GiftCard Missing! This is a two-GiftCard set. If either GiftCard is missing DO NOT add value. Throw away and get a complete set.” Indicia 75 thus comprise indicia underlying first piece 15 and/or second piece 20 indicating that if either first piece 15 or second piece 20 is missing from backer 55, the other of first piece 15 and second piece 20 should be discarded. Indicia 80 include instructions placed adjacent first piece 15 reading “Keep Reloader” and instructions adjacent second piece 20 stating “Give to Student”.

Any of indicia 60, 65, 70, 75, 80 or other indicia, optionally may appear anywhere on backer 55 or card 10. Additional information besides that specifically described and illustrated herein also may be included.

Backer 55 defines window or opening 85 for displaying activation area 90 of card 10. Card 15 includes similar activation area 90. Activation area 90 is adapted for loading cards 15, 20 with monetary value. According to the illustrated embodiment, activation area 90 includes bar code 45. Alternatively, or additionally, activation area 90 may include a magnetic strip, a smart chip or other electronic device, a radio frequency identification device, or other identification device or indicia, such as a card number and event number. Bar code 45 or other activation-area feature optionally represents an account number or otherwise serves to link card 10 to a database or other electronic or manual storage device or system.

Backer 55 is a bi-fold substrate defining fold line 95, about which backer 55 is foldable roughly in half. In FIGS. 3-4, backer 55 is unfolded, i.e. is in an open configuration. According to one embodiment, FIG. 3 illustrates surfaces of backer 55 that will be supported on a rack or other fixture to face a customer of a retail store who is considering purchase of cards 15, 20. After purchase, backer 55 is foldable about fold line 95 such that the FIG. 3 surfaces of backer 55 are folded together and cards 15, 20 are enclosed in a compact package formed by folded backer 55. The surfaces of backer 55 illustrated in FIG. 4 are disposed toward the outside of the compact package, i.e. FIG. 4 illustrates surfaces of backer 55 that will be on the outside when backer 55 is folded about fold line 95, according to embodiments of the invention. Folding in the other direction about fold line 95, or about other fold line(s) of backer 55, also is contemplated.

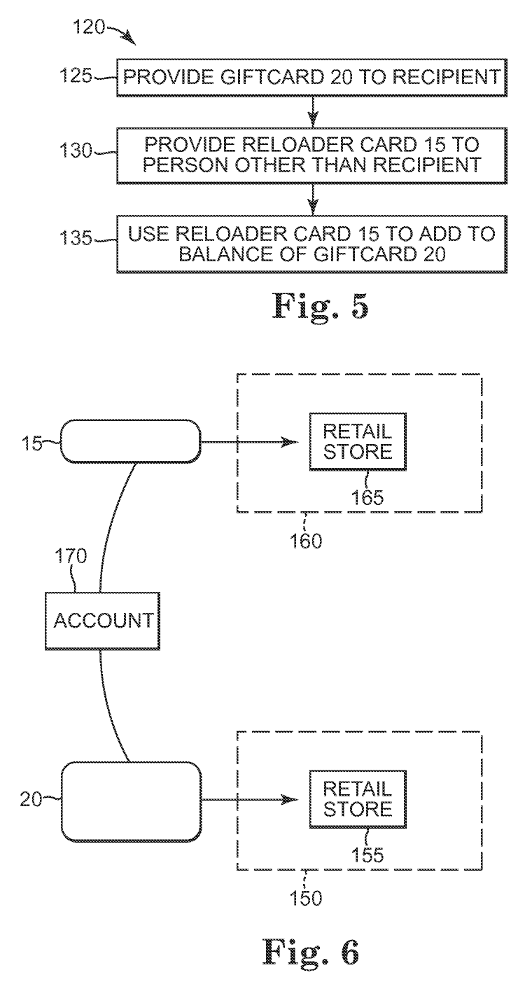

Method embodiments according to the invention are illustrated with respect to FIGS. 5-8. FIG. 5 shows method 120 of reloading a gift card, comprising providing, at 125, gift card 20 to a recipient, gift card 20 being linked to an account or record having a balance. Method 120 further includes providing, at 130, reloader card 15 to a person other than the recipient of gift card 20. Method 120 also includes, at 135, using reloader card 15 to add to the balance of the account or record linked to gift card 20. The method also optionally includes physically detaching gift card 20 from reloader card 15, and using either or both of gift card 20 and reloader card 15 individually to purchase goods and/or services, a value of the goods and/or services being subtracted from the balance of the account or record linked to gift card 20. Reloader card 15 may be used to redeem value or otherwise subtract from the balance of the account or record linked to gift card 20, e.g. in the case where a student does not wish or is unable to redeem the entire balance in the account or record.

With reference to FIG. 6, method 120 also optionally includes providing gift card 20 to a recipient for use in geographic location 150, e.g. at retail store 155 of a chain of retail stores. Geographic location 150 is remote from geographic location 160 of the person to whom reloader card 15 is provided. Reloader card 15 may be brought to retail store 165 of the chain of retail stores and used to add value to financial account or record 170, so that stored-value card 20 may be used at retail store 155, or on a website associated with the chain of retail stores, for example, to purchase goods and/or services.

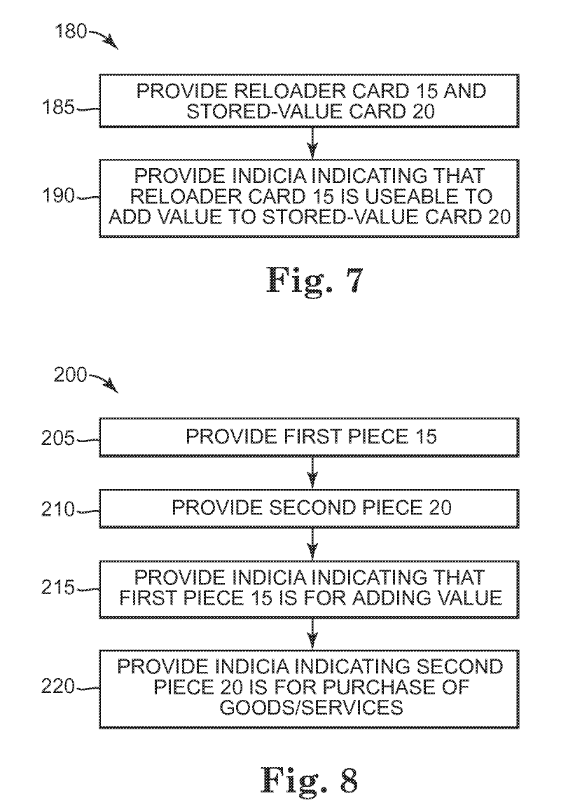

As shown in FIG. 7, method 180 of encouraging the addition of value to stored-value card 20 includes providing, at 185, reloader card 15 and stored-value card 20, and providing, at 190, indicia 40, 60, 65, and/or 70 associated with reloader card 15 and/or stored-value card 20 indicating that reloader card 15 is useable to add value to stored-value card 20. Method 180 also optionally includes supporting reloader card 15 and stored-value card 20 on carrier 55, carrier 55 comprising indicia 60, 65 and/or 70 indicating that reloader card 15 is useable to add value to stored-value card 20. The providing optionally comprises providing reloader card 15 and stored-value card 20 attached together, and method 180 optionally further comprises providing reloader card 15 and stored-value card 20 together at retail store 165, the stored-value card being adapted for purchase of goods and/or services at retail store 165 or at a different retail store 155. An initial value is loaded on to stored-value card 20 at retail store 165. Reloader card 15 is useable for purchase of goods and/or services at retail store 165 or 155. Account-linking or record-linking indicia are provided on both reloader card 15 and stored-value card 20.

FIG. 8 illustrates method 200 of making two-piece financial transaction card 10, the method comprising providing, at 205, first piece 15 linked to financial account or record 170 (FIG. 6), providing, at 210, second piece 20, readily releasably attached to first piece 15, linked to financial account or record 170, providing, at 215, indicia supported by first piece 15 indicating that first piece 15 is for adding value to financial account or record 170, and providing, at 220, indicia supported by second piece 20 indicating that second piece 20 is for the purchase of goods and/or services, a value of the purchased goods and/or services to be deducted from financial account or record 170.

Stored-value cards come in many forms, according to embodiments of the invention. The gift card, like other stored-value cards, can be “recharged” or “reloaded” at the direction of the original customer, the gift recipient, or a third party. The term “loading on” or “loaded on” a card herein should be interpreted to include adding to the balance of a financial account or record associated with the card. The balance associated with the card declines as the card is used, encouraging repeat visits. The card remains in the user's purse or wallet, serving as an advertisement or reminder to re-visit the associated merchant. Gift cards according to embodiments of the invention provide a number of advantages to both the customer and the merchant. Other gift cards and stored-value cards according to embodiments of the invention include loyalty cards, merchandise return cards, electronic gift certificates, employee cards, frequency cards, pre-paid cards, and other types of cards associated with or representing purchasing power or monetary value, for example.

Although the invention has been described with respect to particular embodiments, such embodiments are for illustrative purposes only and should not be considered to limit the invention. Various alternatives and changes will be apparent to those of ordinary skill in the art. For example, cards 15, 20 optionally are physical cards made of plastic, paper, generally stiff paper, other substrate, or the like. Cards 15, 20 also optionally are virtual or electronic cards accessible on a retailer's website, other Internet location, kiosk, or elsewhere, and can be emailed or otherwise transferred electronically. Adding value to card 20 optionally includes adding either a fixed amount or an amount that can be chosen by the customer. Other modifications within the scope of the invention in its various embodiments will be apparent to those of ordinary skill.

What is claimed is:

1. A financial transaction product comprising:
a generally planar structure including:
a first generally rectangular section having a lateral dimension and a longitudinal dimension, the first generally rectangular section comprising:
first encoding means for associating the first generally rectangular section with a financial account, and
first indicia associated with a retail chain,
wherein the first generally rectangular section is adapted for use as a stored-value card, and the longitudinal dimension is substantially smaller than the lateral dimension;
a second generally rectangular section having a lateral dimension and a longitudinal dimension, the second generally rectangular section comprising:
second encoding means for associating the second generally rectangular section with the same financial account that is associated with the first generally rectangular section, and
second indicia associated with the same retail chain as the first indicia,
wherein the second generally rectangular section is adapted for use as a stored-value card, the lateral dimension of the second generally rectangular section is substantially equal to the lateral dimension of the first generally rectangular section; and
a lateral score line separating the first generally rectangular section from the second generally rectangular section, wherein lateral edges of the first and second generally rectangular sections are joined along the lateral score line.

2. The financial transaction product of claim 1, wherein each of the first encoding means and the second encoding means includes a bar code encoded with information identifying the financial account.

3. The financial transaction product of claim 1, wherein the second generally rectangular section is configured for and specifically indicated as being configured for adding additional value to the financial account.

4. The financial transaction product of claim 3, wherein a major surface the second generally rectangular section includes written instructions to the first consumer to present the second generally rectangular section at any store associated with the retail chain of stores and to submit a request that the financial account be funded with a second financial value at a time period following initial activation and funding of the financial account.

5. The financial transaction product of claim 3, wherein the first generally rectangular section is configured for and specifically indicated as being configured for using value from the financial account toward the purchase of one or more of goods and services.

6. The financial transaction product of claim 5, wherein a major surface of one of the first generally rectangular section and the second generally rectangular section includes written instructions to a first consumer that the first consumer should retain the second generally rectangular section and present the first generally rectangular section to a second consumer to facilitate the purchase of one or more of goods or services at any store associated with the retail chain by the second consumer.

7. The financial transaction product of claim 1, wherein the generally planar structure is coupled with a supporting backer extending across a rear surface of the generally planar structure and permitting at least one of the first encoding means and the second encoding means to be mechanically read while the generally planar structure remains coupled with the supporting backer.

8. The financial transaction product of claim 7, wherein the supporting backer includes indicia configured to alert an employee of the retail chain if at least one of the first generally rectangular section and the second generally rectangular section has been removed from the supporting backer such that the employee will be unlikely to activate the financial account when at least one of the first generally rectangular section and the second generally rectangular section has been removed from the supporting backer.

9. The financial transaction product of claim 1, wherein:
the generally planar structure is configured to be provided at a local location associated with the retail chain with a request that the financial account be funded with a first financial value resulting in a first financial value being funded to the financial account based on one of the first means for encoding and the second means for encoding;
the first and second generally rectangular sections are configured to be broken apart from one another along the lateral score line without use of tools such that a second consumer can retain the second generally rectangular section and present the first generally rectangular section to a first consumer to facilitate the purchase of goods or services at a remote location associated with the retail chain by the first consumer; and
after the first consumer has exhausted a portion of funds associated with the financial account through purchases at one or more remote locations associated with the retail chain using the first generally rectangular section, the second generally rectangular section is configured to be presented at the local location associated with the retail chain with a second request that the financial account be funded with a second financial value in a manner resulting in the second financial value being added to the financial account based in part on the second means for encoding.

10. A method comprising:
(a) providing a generally planar structure including:
a first generally rectangular section having a lateral dimension and a longitudinal dimension, the first generally rectangular section comprising:
first encoding means for associating the first generally rectangular section with a financial account, and
first indicia associated with a retail chain,
wherein the first generally rectangular section is adapted for use as a stored-value card, and the longitudinal dimension is substantially smaller than the lateral dimension;
a second generally rectangular section having a lateral dimension and a longitudinal dimension, the second generally rectangular section comprising:
second encoding means for associating the second generally rectangular section with the same financial account associated with the first generally rectangular section, and
second indicia associated with the same retail chain as the first indicia,
wherein the second generally rectangular section is adapted for use as a stored-value card, and the lateral dimension of the second generally rectangular section is substantially equal to the lateral dimension of the first generally rectangular section; and
a lateral score line separating the first generally rectangular section from the second generally rectangular section, wherein lateral edges of the first and second generally rectangular sections are joined along the lateral score line.

11. The method of claim 10, wherein the encoding means comprises a bar code.

12. The method of claim 10, wherein the longitudinal dimension of the second generally rectangular section is less than about half the longitudinal dimension of the first generally rectangular section.

13. The method of claim 10, further comprising:
(b) submitting a first request at a local location associated with the retail chain that the account be funded with a first financial value;
(c) separating the first and second generally rectangular sections by breaking the generally planar structure along the lateral score line;
(d) while retaining the second generally rectangular section, presenting the first generally rectangular section to a first consumer to facilitate the purchase by the first consumer of goods or services at a remote location associated with the retail chain; and
(e) after the first consumer has exhausted a portion of the funds associated with the financial account through purchases at one or more remote locations associated with the retail chain using the first generally rectangular section, presenting the second generally rectangular section at the local location associated with the retail chain and submitting a second request at the local location that the account be funded with a second financial value;
wherein (b), (c), (d), and (e) are all performed by a second consumer.

14. The method of claim 13, further comprising repeating step (e).

15. The method of claim 13, further comprising using the second generally rectangular section as a stored-value card at a local location associated with the retail chain.

16. The method of claim 13, wherein a major surface of the second generally rectangular section includes written instructions associated with the performance of step (d).

17. The method of claim 16, wherein a major surface of the first generally rectangular section includes written instructions associated with the performance of step (d).

18. The method of claim 13, wherein a major surface of the second generally rectangular section includes written instructions associated with the performance of step (e).

19. The method of claim 18, wherein a major surface of the first generally rectangular section includes written instructions associated with the performance of step (e).

20. The method of claim 13, further comprising:
when the second consumer views the first generally rectangular section and the second generally rectangular section as part of the generally planar structure in a retail display at the local location, the second consumer learns that the second generally rectangular section is useable to add value to the first generally rectangular section and that the first generally rectangular section is redeemable for merchandise or services at any location included in the retail chain.

21. The method of claim 9, further comprising:
providing a supporting backer coupled to and extending across a rear surface of the generally planar structure and permitting at least one of the first encoding means and the second encoding means to be mechanically read by a point-of-sale terminal associated with the retail store while the generally planar structure remains coupled with the supporting backer;
wherein the supporting backer includes indicia configured to alert an employee of the retail chain not to activate the financial account when at least one of the first generally rectangular section and the second generally rectangular section has been removed from the supporting backer.
